(19) United States
(12) Patent Application Publication
(10) Pub. No.: US 2026/0005572 A1
(43) Pub. Date: Jan. 1, 2026

(54) STATOR

(71) Applicant: DENSO CORPORATION, Kariya-city (JP)

(72) Inventor: Hiroshi IMAI, Kariya-city (JP)

(73) Assignee: DENSO CORPORATION, Kariya-city (JP)

(21) Appl. No.: 19/316,365

(22) Filed: Sep. 2, 2025

Related U.S. Application Data
(63) Continuation of application No. PCT/JP2023/046775, filed on Dec. 26, 2023.

(30) Foreign Application Priority Data
Mar. 2, 2023 (JP) 2023-032109

(51) Int. Cl. H02K 3/52

(52) U.S. Cl. CPC H02K 3/522; H02K 2203/06; H02K 2203/12

(57) ABSTRACT

A stator includes a plurality of core components, a plurality of windings, and a plurality of insulators. The core components include a yoke component and a teeth portion protruding from the yoke component. The windings include a winding portion wound around the teeth portion, and a crossover wire connecting the winding portions. The insulators include an insulating portion insulating between the teeth portion and the winding portion, and a joining portion joining end portions on the inner side in the radial direction of the insulating portions. The crossover wire is led out from the winding portion in a direction in which the winding portion is loosened. The joining portion includes a hook portion that extends in an axial direction of the joining portion. The crossover wire is hooked onto the hook portion so as to be wired on an inner circumferential side of the insulator relative to the hook portion.

### CROSS-REFERENCE TO RELATED APPLICATION

The present application is a continuation application of International Application No. PCT/JP2023/046775, filed on Dec. 26, 2023, which claims priority to Japanese Patent Application No. 2023-032109, filed on Mar. 2, 2023. The contents of these applications are incorporated herein by reference in their entirety.

### BACKGROUND

The present disclosure relates to a stator. A so-called segmented-core-type stator is known. The segmented-core-type stator is configured by a plurality of stator components. The plurality of stator components are integrated by an upper stator component being assembled to a lower stator component from an axial direction of the stator.

### SUMMARY

An aspect of the present disclosure provides a stator that includes a plurality of core components, a plurality of windings, and a plurality of insulators. The plurality of core components include a yoke component that configures an annular yoke and is divided in a circumferential direction of the yoke, and a teeth portion that protrudes from the yoke component toward an inner side in a radial direction of the yoke. The plurality of windings include a winding portion that is wound around the teeth portion, and a crossover wire that connects the winding portions to each other. The plurality of insulators include an insulating portion that is provided in the core component and insulates between the teeth portion and the winding portion, and a joining portion that joins end portions on the inner side in the radial direction of the insulating portions to each other. The crossover wire is led out from the winding portion in a direction in which the winding portion is loosened. The joining portion includes a hook portion that extends in an axial direction of the joining portion. The crossover wire is hooked onto the hook portion so as to be wired on an inner circumferential side of the insulator relative to the hook portion.

### BRIEF DESCRIPTION OF THE DRAWINGS

In the accompanying drawings:

FIG. 1 is a perspective view of a stator according to an embodiment of the present disclosure;

FIG. 2 is a perspective view of a stator component according to the embodiment of the present disclosure;

FIG. 3 is a plan view of the stator component according to the embodiment of the present disclosure;

FIG. 4 is an enlarged view of a portion of FIG. 3;

FIG. 5 is a perspective view of an insulator according to the embodiment of the present disclosure;

FIG. 6 is a perspective view of a portion of the insulator according to the embodiment of the present disclosure;

FIG. 7 is a perspective view of a portion of the insulator in a modification; and

FIG. 8 is a plan view of an example of a stator component.

### DESCRIPTION OF THE EMBODIMENTS

JP 5502115 B2 discloses a so-called segmented-core-type stator. The segmented-core-type stator is configured by a plurality of stator components. The plurality of stator components are integrated by an upper stator component being assembled to a lower stator component from an axial direction of the stator.

As a result of detailed examination by the inventors, an issue has been found in that, regarding the so-called segmented-core-type stator, a stator in which a length in an axial direction can be shortened, compared to that in a case in which crossover wires intersect, is desired.

The present disclosure provides a stator in which a length in an axial direction can be shortened, compared to that in a case in which crossover wires intersect

An exemplary embodiment of the present disclosure provides a stator that includes: a plurality of core components that includes a yoke component that configures an annular yoke and is divided in a circumferential direction of the yoke, and a teeth portion that protrudes from the yoke component toward an inner side in a radial direction of the yoke; a plurality of windings that includes a winding portion that is wound around the teeth portion, and a crossover wire that connects the winding portions to each other; and a plurality of insulators that includes an insulating portion that is provided in the core component and insulates between the teeth portion and the winding portion, and a joining portion that joins end portions on the inner side in the radial direction of the insulating portions to each other, in which the crossover wire is led out from the winding portion in a direction in which the winding portion is loosened, the joining portion includes a hook portion that extends in an axial direction of the joining portion, and the crossover wire is hooked onto the hook portion so as to be wired on an inner circumferential side of the insulator relative to the hook portion.

As a result of the exemplary embodiment, a stator in which a length in an axial direction can be shortened, compared to a case in which crossover wires intersect, is provided.

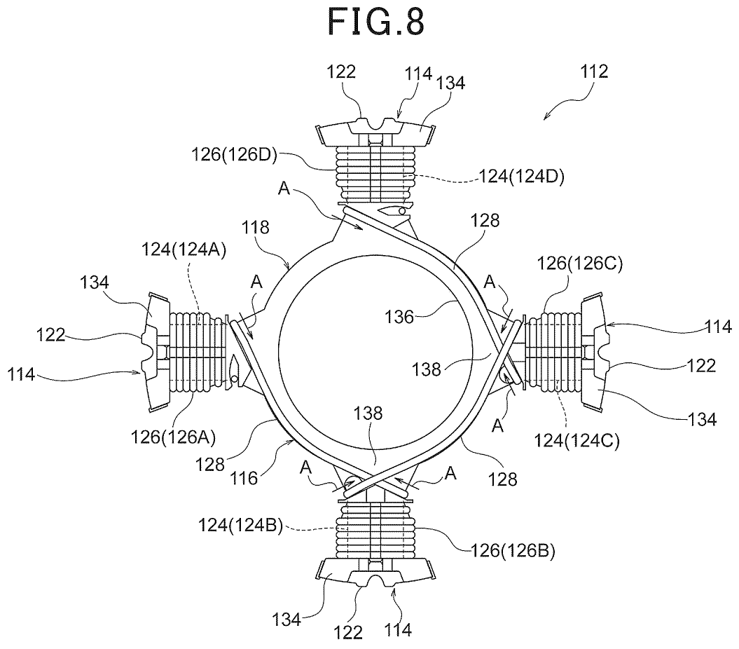

FIG. 8 is a plan view of an example of a stator component 112. Each stator component 112 includes a plurality of core components 114, a winding 116, and an insulator 118. Each core component 114 includes a yoke component 122 that composes an annular yoke and is divided in a circumferential direction of the yoke, and a teeth portion 124 that protrudes from the yoke component 122 toward an inner side in a radial direction of the yoke. The winding 116 includes a winding portion 126 that is wound around each teeth portion 124 and a crossover wire 128 that connects the winding portions 126 to each other. The insulator 118 includes an insulating portion 134 that is provided in the core component 114 and insulates between the teeth portion 124 and the winding portion 126, and a joining portion 136 that joins end portions on the inner side in the radial direction of the insulating portions 134 to each other.

The winding 116 is wound around the plurality of teeth portions 124 in order along the circumferential direction of the stator component 112. That is, the winding 116 is wound around a teeth portion 124A, a teeth portion 124B, a teeth portion 124C, and a teeth portion 124D, in this order. As a result, a winding portion 126A, a winding portion 126B, a winding portion 126C, and a winding portion 126D are formed. Each crossover wire 128 is led out from the winding portion 126 in a direction in which the winding portion 126 is tightened (arrow A directions).

The crossover wires 128 are respectively connected to a terminal portion at a start of winding and a terminal portion at an end of winding of the winding portion 126B positioned in an intermediate portion (second portion) in the order of winding of the winding portions 126A to 126D. The crossover wire 128 connected to the terminal portion at the start of winding and the crossover wire 128 connected to the terminal portion at the end of winding intersect at a connection portion 138 between the insulating portion 134 and the joining portion 136 corresponding to the winding portion 126B. In a similar manner, the crossover wires 128 are respectively connected to the terminal portion at the start of winding and the terminal portion at the end winding of the winding portion 126C positioned in an intermediate portion (third portion) in the order of winding of the winding portions 126A to 126D. The crossover wire 128 connected to the terminal portion at the start of winding and the crossover wire 128 connected to the terminal portion at the end of winding intersect at the connection portion 138 between the insulating portion 134 and the joining portion 136 corresponding to the winding portion 126C.

However, when the crossover wire 128 is led out from the winding portion 126 in the direction in which the winding portion 126 is tightened, the crossover wire 128 connected to the terminal portion at the start of winding and the crossover wire 128 connected to the terminal portion at the end of winding of the winding portion 126 positioned in the intermediate portion in the order of winding of the plurality of winding portions 126 intersect at the connection portion 138 between the insulating portion 134 and the joining portion 136. When the crossover wires 128 intersect in this manner, a length in the axial direction of the stator configured by the plurality of stator components 112 increases by this amount.

An object of the present embodiment is to provide a stator in which the length in the axial direction can be shortened, compared to a case in which the crossover wires intersect.

A first aspect of the present embodiment is a stator including: a plurality of core components having a yoke component that configures an annular yoke and is divided in a circumferential direction of the yoke, and a teeth portion that protrudes from the yoke component toward an inner side in a radial direction of the yoke; a plurality of windings having a winding portion that is wound around the teeth portion and a crossover wire that connects the winding portions to each other; and a plurality of insulators having an insulating portion that is provided in the core component and insulates between the teeth portion and the winding portion, and a joining portion that joins end portions on the inner side in the radial direction of the insulating portions to each other, in which the crossover wire is led out from the winding portion in a direction in which the winding portion is loosened, the joining portion includes a hook portion that extends in an axial direction of the joining portion, and the crossover wire is hooked onto the hook portion so as to be wired on an inner circumferential side of the insulator relative to the hook portion.

According to the first aspect of the present embodiment, the crossover wire is led out from the winding portion in the direction in which the winding portion is loosened. Therefore, because the crossover wires connected to the terminal portion at the start of winding and the terminal portion at the end of winding of the winding portion positioned intermediately among the plurality of winding portions do not intersect as a result of being wired toward sides differing from each other, compared to a case in which the crossover wires intersect, a length in an axial direction of the stator can be shortened.

Here, when the crossover wire is led out from the winding portion in the direction in which the winding portion is loosened, the winding portion may loosen. However, in the invention according to claim 1, the joining portion includes the hook portion that extends in the axial direction of the joining portion. The crossover wire is hooked onto the hooking portion such that the crossover wire is wired on the inner circumferential side of the insulator relative to the hook portion. Therefore, a lead-out portion of the crossover wire led out from the terminal portion of the winding portion can be wired toward the inner circumferential side of the insulator. As a result, because tensile force toward the inner circumferential side of the insulator acts on the lead-out portion of the crossover wire, even if the crossover wire is led out from the winding portion in the direction in which the winding portion is loosened, loosening of the winding portion is suppressed.

A second aspect of the present embodiment is the stator according to the first aspect of the present embodiment in which a hooking position of the crossover wire by the hook portion is set to a position toward the inner circumferential side of the insulator along the axial direction of the teeth portion, from the terminal portion of the winding portion.

According to the second aspect of the present embodiment, the hooking position of the crossover wire by the hook portion is set to a position toward the inner circumferential side of the insulator along the axial direction of the teeth portion, from the terminal portion of the winding portion. Therefore, because tensile force acts on the lead-out portion of the crossover wire toward the inner circumferential side of the insulator along the axial direction of the teeth portion, loosening of the winding portion can be more effectively suppressed.

A third aspect of the present embodiment is the stator according to the first aspect or the second aspect of the present embodiment in which the hook portion is formed into a wall shape extending in the circumferential direction of the joining portion.

According to the third aspect of the present embodiment, the hook portion is formed into a wall shape. Therefore, for example, compared to when the hook portion is formed into a pin shape, rigidity of the hook portion can be ensured. As a result, even in a state in which the crossover wire is hooked onto the hook portion, collapse of the hook portion can be suppressed. In addition, as a result of the hook portion being formed into the wall shape, the hook portion serves as a rib. Therefore, rigidity of the joining portion can be enhanced.

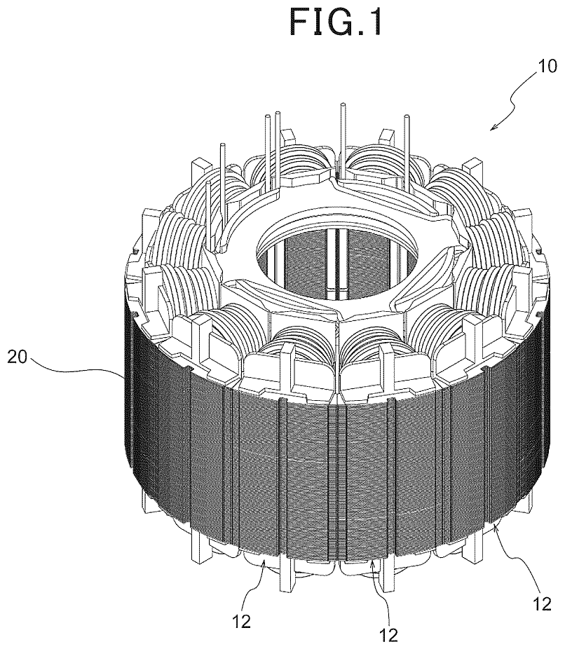

FIG. 1 is a perspective view of a stator 10 according to the present embodiment. The stator 10 is a so-called segmented-core-type stator. A basic configuration of the segmented-core-type stator is described in JP 5502115 B2. The stator is applied to an inner-rotor-type brushless motor. That is, a rotor (not shown) is rotatably housed inside the stator 10, and a brushless motor is configured by the stator 10 and the rotor.

The stator 10 is configured by a plurality of stator components 12. The stator 10 has a U-phase, a V-phase, and a W-phase. A quantity of the plurality of stator components 21 corresponds to a quantity of the U-phase, V-phase, and the W-phase. That is, the stator 10 includes the U-phase stator component 12, the V-phase stator component 12, and the W-phase stator component 12. The plurality of stator components 12 are integrated by being assembled to each other from the axial direction of the stator 10.

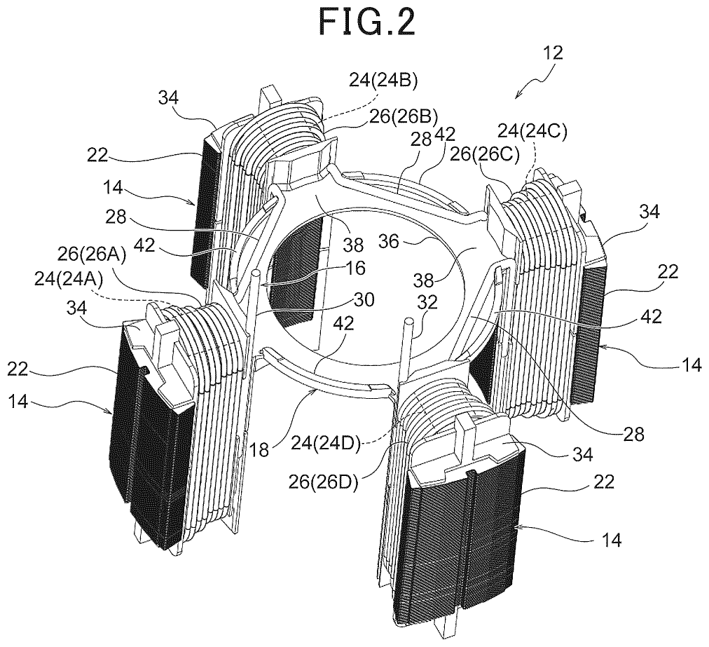

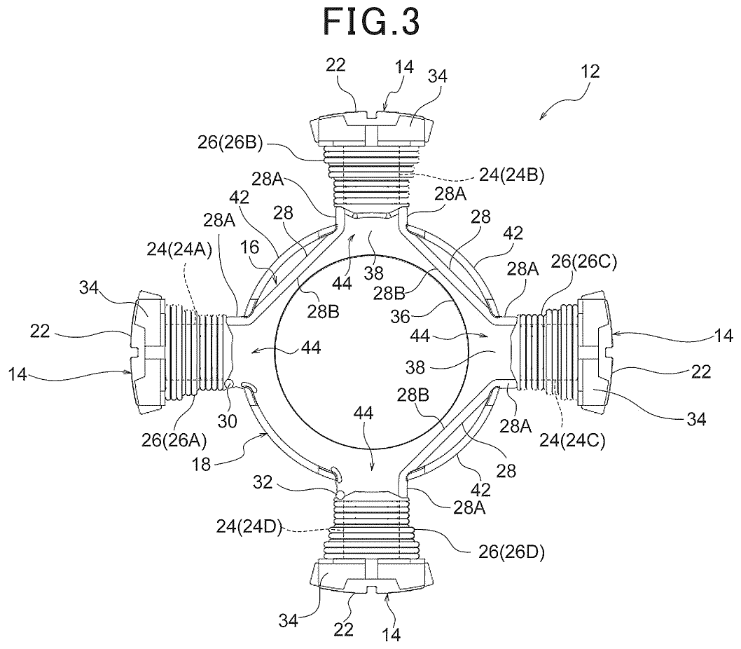

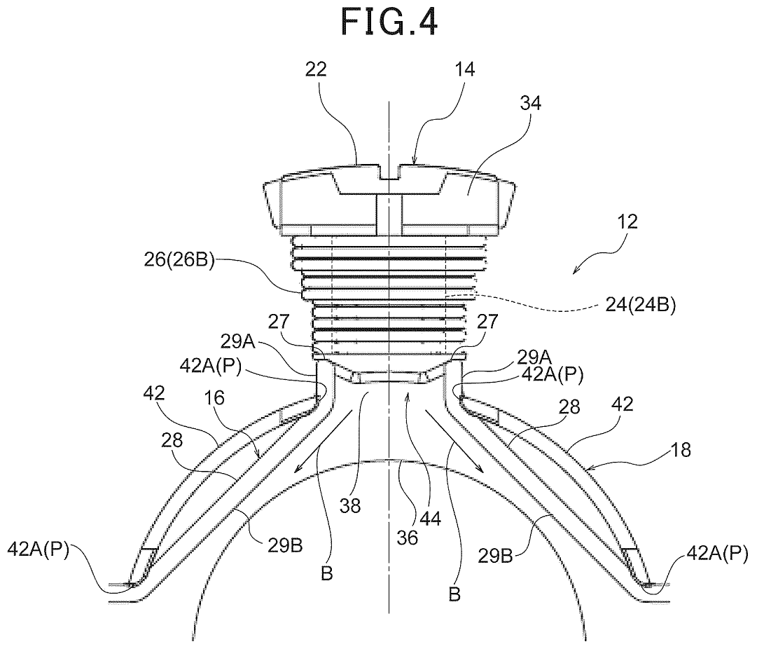

FIG. 2 is a perspective view of the stator component 12 according to the present embodiment. In addition, FIG. 3 is a plan view of the stator component 12 according to the present embodiment. FIG. 4 is an enlarged view of a portion of FIG. 3.

The stator component 12 includes a plurality of core components 14, a winding 16, and an insulator 18. Each core component 14 includes a yoke component 22 that configures an annular yoke 20 (see FIG. 1) and is divided in the circumferential direction of the yoke 20, and a teeth portion 24 that protrudes from the yoke component 22 toward the inner side in the radial direction of the yoke 20. The winding 16 includes a winding portion 26 that is wound around each teeth portion 24, a crossover wire 28 that connects the winding portions 26 to each other, a winding terminal portion 30 at the start of winding, and a winding terminal portion 32 at the end of winding. The insulator 18 includes an insulating portion 34 that is provided in each core component 14 and insulates between the teeth portion 24 and the winding portion 26, and a joining portion 36 that joins end portions on the inner side in the radial direction of the insulating portions 34 to each other.

The winding 16 is wound around the plurality of teeth portions 24 in order along the circumferential direction of the stator component 112. That is, the winding 16 is wound around a teeth portion 24A, a teeth portion 24B, a teeth portion 24C, and a teeth portion 24D in this order. As a result, a winding portion 26A, a winding portion 26B, a winding portion 26C, and a winding portion 26D are formed. The crossover wire 28 is led out from the winding portion 26 in a direction in which the winding portion 26 is loosened (arrow B directions shown in FIG. 4).

The crossover wires 28 are respectively connected to the terminal portion at the start of winding and the terminal portion at the end of winding of the winding portion 26B positioned in an intermediate portion (second portion) in the order of winding of the winding portions 26A to 26D. The crossover wire 28 connected to the terminal portion at the start of winding and the crossover wire 28 connected to the terminal portion at the end of winding do not intersect at a connection portion 38 between the insulating portion 34 and the joining portion 36 corresponding to the winding portion 26B, but rather, are wired toward sides differing from each other (arrow B directions) from the winding portion 26B. In a similar manner, the crossover wires 28 are respectively connected to the terminal portion at the start of winding and the terminal portion at the end of winding of the winding portion 26C positioned in an intermediate portion (third portion) in the order of winding of the winding portions 26A to 26D. The crossover wire 28 connected to the terminal portion at the start of winding and the crossover wire 28 connected to the terminal portion at the end of winding do not intersect at the connection portion 38 between the insulating portion 34 and the joining portion 36 corresponding to the winding portion 26C, but rather, are wired toward sides differing from each other (arrow B directions) from the winding portion 26C.

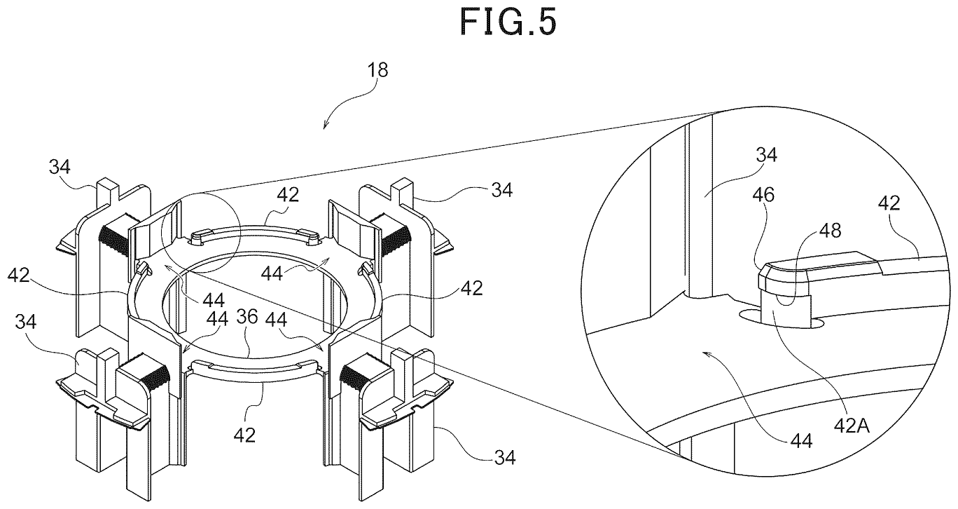

FIG. 5 is a perspective view of the insulator 18 according to the present embodiment. As an example, the joining portion 36 is formed into a circular annular plate shape of which the axial direction of the joining portion 36 is a plate thickness direction. A plurality of hook portions 42 are formed in the joining portion 36. The plurality of hook portions 42 are formed in the circumferential direction of the joining portion 36 with spaces therebetween. Each hook portion 42 is formed into a wall shape that extends from a surface on one side in the axial direction of the joining portion 36 toward one side in the axial direction of the joining portion 36. The hook portion 42 is formed in a portion on an outer circumferential side of the surface on one side in the axial direction of the joining portion 36 and extends in a circular arc shape along an outer circumference of the joining portion 36. The hook portion 42 is positioned between adjacent insulating portions 34. In other words, the plurality of hook portions 42 have notches 44 positioned to correspond to the insulating portions 34.

As shown in FIG. 4, the crossover wire 28 is hooked onto the hook portion 42 so as to be wired on the inner circumferential side of the insulator 18 relative to the hook portion 42. If the circumferential direction of the joining portion 36 is an extension direction of the hook portion 42, specifically, the crossover wire 28 is hooked onto an end portion 42A (that is, an end portion of the notch 44) in the extension direction of the hook portion 42.

The end portion 42A of the hook portion 42 corresponds to a hooking position P of the crossover wire 28 by the hook portion 42. The hooking position P of the crossover wire 28 by the hook portion 42 is set to a position further toward the inner circumferential side of the insulator 18 than the terminal portion 27 of the winding portion 26. More specifically, the hooking position P is set to a position toward the inner circumferential side of the insulator 18 along the axial direction of the teeth portion 24, from the terminal portion 27 of the winding portion 26.

As a result, a lead-out portion 29A of the crossover wire 28 led out from the terminal portion 27 of the winding portion 26 extends in a straight line toward the inner circumferential side of the insulator 18 along the axial direction of the teeth portion 24. In addition, an intermediate portion 29B of the crossover wire 28 positioned between the end portions 24A on both sides of the hook portion 42 extend in a straight line connecting the end portions 42A on both sides of the hook portion 42.

As shown in FIG. 5, a tapered portion 46 is formed in the end portion 42A of the hook portion 42. The taper portion 46 is formed in an upper end portion in a height direction of the hook portion 42. A shape of the taper portion 46 may be a chamfered shape or an R shape. In addition, a return portion 48 is formed in the end portion 42A of the hook portion 42. The return portion 48 protrudes toward the inner side of the notch 44 from the upper end portion in the height direction of the hook portion 42.

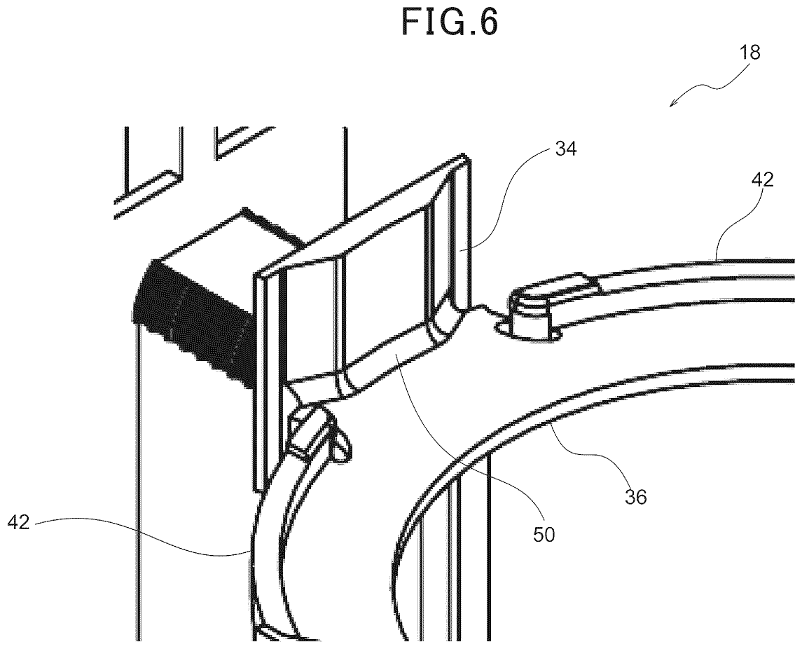

FIG. 6 is a perspective view of a portion of the insulator 18 according to the present embodiment. In a connection portion to the joining portion 36 of the insulating portion 34 corresponding to the above-described winding portion 26B, among the plurality of insulating portions 34 formed in the insulator 18, a built-up portion 50 is formed. The built-up portion 50 is formed into a shape in which the connection portion (corner portion) of the insulating portion 34 to the joining portion 36 is built up.

Next, workings and effects according to the present embodiment will be described.

In the stator 10 according to the present embodiment, the crossover wire 28 is led out from the winding portion 26 in the direction in which the winding portion 26 is loosened. Therefore, because the crossover wires 28 connected to the terminal portion at the start of winding and the terminal portion at the end of winding of the winding portion 26 positioned intermediately among the plurality of wound portions 26 do not intersect by being wired toward sides differing from each other, compared to a case in which the crossover wires 28 intersect, the length in the axial direction of the stator 10 configured by the plurality of stator components 12 can be shortened.

Here, when the crossover wire 28 is led out from the winding portion 26 in the direction in which the winding portion 26 is loosened, the winding portion 26 may loosen. However, in the stator 10 according to the present embodiment, the joining portion 42 includes the hook portion 42 that extends in the axial direction of the joining portion 36. The crossover wire 28 is hooked onto the hook portion 42 so as to be wired on the inner circumferential side of the insulator 18 relative to the hook portion 42. Therefore, the lead-out portion 29A of the crossover wire 28 led out from the terminal portion 27 of the winding portion 26 can be wired toward the inner circumferential side of the insulator 18. As a result, tensile force toward the inner circumferential side of the insulator 18 acts on the lead-out portion 29A of the crossover wire 28. Consequently, even if the crossover wire 28 is led out from the winding portion 26 in the direction in which the winding portion 26 is loosened, loosening of the winding portion 26 can be suppressed.

In addition, because all that is required is for the crossover wire 28 to be hooked onto the hook portion 42, for example, compared to a case in which a fixing member for fixing the crossover wire 28 to the joining portion 36 or the like is used, increase in a number of parts can be prevented.

Furthermore, because the crossover wires 28 do not intersect, for example, compared to a case in which the crossover wires 28 intersect, a length of the winding 16 can be shortened. As a result, resistance in the winding 16 can be reduced. Consequently, electrical loss (current loss) due to the winding 16 can be suppressed.

In addition, in the stator 10 according to the present embodiment, the hooking position P of the crossover wire 28 by the hook portion 42 is set to a position toward the inner circumferential side of the insulator 18 along the axial direction of the teeth portion 24, from the terminal portion 27 of the winding portion 26. Therefore, because tensile force acts on the lead-out portion 29A of the crossover wire 28 toward the inner circumferential side of the insulator 18 along the axial direction of the teeth portion 24, loosening of the winding portion 26 can be even more effectively suppressed.

Furthermore, in the stator 10 according to the present embodiment, the hook portion 42 is formed into a wall shape. Therefore, compared to a case in which the hook portion 42 is formed into a pin shape, for example, rigidity of the hook portion 42 can be ensured. As a result, even in a state in which the crossover wire 28 is hooked onto the hook portion 42, collapse of the hook portion 42 can be suppressed. In addition, as a result of the hook portion 42 being formed into the wall shape, the hook portion 42 serves as a rib. Therefore, rigidity of the joining portion 36 can be enhanced.

Furthermore, the tapered portion 46 is formed in the upper end portion in the height direction of the hook portion 42 in the end portion 42A in the extension direction of the hook portion 42. Therefore, workability when the crossover wire 28 is hooked onto the end portion 42A from an upper side in the height direction of the hook portion 42 can be improved.

In addition, the return portion 48 is formed in the end portion 42A of the hook portion 42. Therefore, detachment from the hook portion 42 of the crossover wire 28 hooked onto the end portion 42A of the hook portion 42 can be suppressed.

Furthermore, the built-up portion 50 is formed in the connection portion to the joining portion 36 of the insulating portion 34 corresponding to the above-described winding portion 26B, among the plurality of insulating portions 34 formed in the insulator 18. Therefore, even in cases in which load applied to the insulating portion 34 is greater than that on other insulating portions 34 as a result of the crossover wires 28 being connected to the terminal portion at the start of winding and the terminal portion at the end of winding of the winding portion 26, collapse and deformation of the insulating portion 34 can be suppressed.

Next, modifications according to the present embodiment will be described.

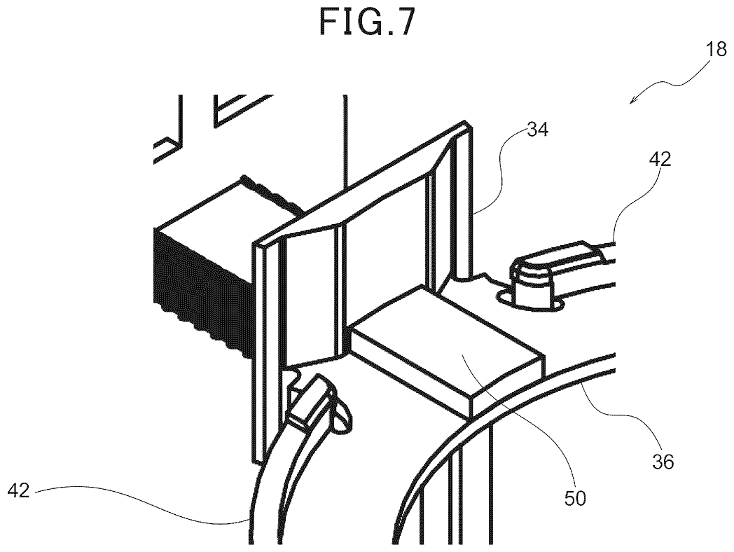

FIG. 7 is a perspective view of a portion of the insulator 18 in a modification. In the present modification, the built-up portion 50 is formed into a rib shape. Even in a configuration such as this, collapse and deformation of the insulating portion 34 can be suppressed.

In addition, according to the above-described embodiment, the built-up portion 50 may also be formed in the connection portion to the joining portion 36 of the insulating portion 34 corresponding to the above-described winding portion 26C. Furthermore, according to the above-described embodiment, the built-up portion 50 may be formed in the connection portion to the joining portion 36 of all insulating portions 34.

In addition, according to the above-described embodiment, the hooking position P of the crossover wire 28 by the hook portion 42 may be a position other than that shown in FIG. 4 as long as the position is further toward the inner circumferential side of the insulator 18 than the terminal portion 27 of the winding portion 26. That is, the hooking position P may be shifted in the circumferential direction of the joining portion 36 relative to the position shown in FIG. 4.

Furthermore, according to the present embodiment, the hook portion 42 is formed into a wall shape, but may be formed into a shape other than the wall shape. In addition, for example, the hook portions 42 may be formed in the joining portion 36 in positions corresponding to the hooking positions P.

The present embodiment is described above. However, the present disclosure is not limited to the description above. It goes without saying that various modifications are possible without departing from the spirit of the present invention.

What is claimed is:

1. A stator comprising:
a plurality of core components that include
a yoke component that configures an annular yoke and is divided in a circumferential direction of the yoke, and
a teeth portion that protrudes from the yoke component toward an inner side in a radial direction of the yoke;
a plurality of windings that include
a winding portion that is wound around the teeth portion, and
a crossover wire that connects the winding portions to each other; and
a plurality of insulators that include
an insulating portion that is provided in the core component and insulates between the teeth portion and the winding portion, and
a joining portion that joins end portions on the inner side in the radial direction of the insulating portions to each other, wherein
the crossover wire is led out from the winding portion in a direction in which the winding portion is loosened,
the joining portion includes a hook portion that extends in an axial direction of the joining portion, and
the crossover wire is hooked onto the hook portion so as to be wired on an inner circumferential side of the insulator relative to the hook portion.

2. The stator according to claim 1, wherein:
a hooking position of the crossover wire by the hook portion is set to a position toward the inner circumferential side of the insulator along the axial direction of the teeth portion, from a terminal portion of the winding portion.

3. The stator according to claim 1, wherein:
the hook portion is formed into a wall shape.

4. The stator according to claim 2, wherein:
the hook portion is formed into a wall shape.
